(19) United States
(12) Patent Application Publication
(10) Pub. No.: US 2026/0274053 A1
(43) Pub. Date: Sep. 17, 2026

(54) Automobile Roof Assembly

(71) Applicant: Glen Pratt, Amarillo, TX (US)

(72) Inventor: Glen Pratt, Amarillo, TX (US)

(21) Appl. No.: 19/649,389

(22) Filed: Apr. 16, 2026

Related U.S. Application Data
(63) Continuation of application No. 17/951,472, filed on Sep. 23, 2022, now Pat. No. 12,623,523.
(60) Provisional application No. 63/247,675, filed on Sep. 23, 2021.

(51) Int. Cl. B60J 7/16; B60J 7/10; B60R 9/04; E04H 15/06

(52) U.S. Cl. CPC B60J 7/1621; B60J 7/106; B60R 9/04; E04H 15/06

(57) ABSTRACT

An automobile accessory system is disclosed comprising a ring rack, a roof, and a cargo holder. In one embodiment, the ring rack includes side rails, an end rail, and mounting brackets configured to mount the rack to a vehicle roof. A multi-tier roof, such as a two-tier molded fiberglass roof, is coupled to the ring rack by one or more hinged mounting brackets and may be movable between open and closed positions using one or more actuators, such as pneumatic struts. The roof includes a forward section and a rearward section having different heights. A cargo holder may be associated with the roof and includes one or more gates coupled by hinges to allow access to stored cargo.

### CROSS-REFERENCE TO RELATED APPLICATIONS

This application is a continuation application of U.S. application Ser. No. 17/951,472 filed on Sep. 23, 2022, which claims priority to U.S. Provisional Patent Application No. 63/247,675, filed on Sep. 23, 2021, the disclosures of which are incorporated herein by reference. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### BACKGROUND OF THE INVENTION

### 1. Field of the Invention

The present application relates to automobile accessories, and combinations thereof, for use with vehicles. More particularly, the application relates to accessories for addition to, modification of, or installation on vehicles in the aftermarket, including four-wheel-drive vehicles such as Jeeps and Broncos.

### 2. Description of Related Art

Vehicle owners often purchase multiple aftermarket items, including assemblies and mounting brackets, in order to mount cargo and accessories to a vehicle rooftop. This is particularly true for off-road capable vehicles, such as those intended for camping or extended expeditions.

Modifying a vehicle after purchase is often expensive and time-consuming for the vehicle owner. Such aftermarket additions also typically decrease aerodynamic performance and fuel efficiency. These problems are further compounded when vehicle owners seek to use the vehicle as a platform for camping, as the vehicle must accommodate additional uses and equipment.

Accordingly, there is a need for after-market automobile accessories that address these deficiencies in currently available products.

### OBJECTS AND SUMMARY OF THE INVENTION

Disclosed embodiments relate to automobile accessories, or assemblyies of such accessories, that address deficiencies in currently known products. The present disclosure describes automobiles to which an aftermarket ring rack, roof, cargo holder, extension tub, and/or rear vehicle protection system are attached. One embodiment comprises a ring rack, a roof, and a cargo holder. More specifically, one embodiment may comprise a U-shaped mounting rack accessory system referred to herein as a ring rack; a raisable, fixed, or multi-tier roof that may comprise a tent; and a vehicle-top cargo system referred to herein as a cargo holder.

The disclosed ring rack may be constructed from metal, such as steel and/or aluminum, and may comprise two side rails, an end rail, and one or more mounting brackets configured to mount the ring rack to a roof of an automobile. The ring rack may further comprise one or more cutouts, which reduce weight and provide accessory attachment means. The roof may be a single-tier roof. In certain embodiments, the roof is a two-tier roof comprising a first forward section and a second rearward section, wherein the second section has an increased height relative to the first section. The roof may comprise a molded fiberglass construction, and optionally one or both of the first section and the second section may include one or more ribs to increase strength. The first section, the second section, or both, may include angled end portions to facilitate wind deflection and increase structural strength.

The first section of the roof defines a surface that, in association with the cargo holder, defines a cargo holding section. An exemplary cargo holder comprises a front rail, an end rail, and two side gates. The cargo holder may further include a fairing oriented at substantially the same angle as an angled end portion of the first section of the roof to facilitate wind deflection. The two side gates are coupled to the front rail by hinges to allow user access to cargo stored in the cargo holding section. The side gates may further comprise a spring-actuated latch, a latch catch, and an actuation handle configured to move the side gates between open and closed positions.

The front section of the roof is coupled to the ring rack by hinged mounting brackets. Pneumatic struts may lift and position the roof in an open position as the roof pivots about the hinged mounting brackets. The roof optionally may include one or more windows and/or faux windows. In certain embodiments, the roof includes a forward faux window and a rear faux window.

Additionally, custom bumper accessories also are disclosed and may include one or more features useful or desired by a user. For example, the bumper may comprise one or more of: a step, a coupler for attaching tow ropes or chains, one or more built-in storage sections comprising an access door and a door latch, one or more aftermarket lighting accommodations, and combinations thereof.

The disclosed automobile assembly may further comprise one or more components configured to extend an automobile body length. These components may include extenders and an extension tub connected to the automobile by the extenders. The extenders and extension tub allow the length of the automobile to be increased to accommodate for, e.g., an increased internal and external cargo area, cargo and accessory mounting systems, a camping bed, a bunk, a tent, and/or a modified roof.

In one embodiment, the ring rack is made from steel, aluminum, or a combination thereof and comprises two side rails, an end rail, and one or more mounting brackets configured to mount the rack to a rooftop of an automobile. The ring rack may include one or more cutouts to reduce the weight of the ring rack. A two-tier molded fiberglass roof may be coupled to the ring rack by hinged mounting brackets coupled to a front section of the roof. The roof comprises a first forward section and a second rearward section, the second section having an increased height relative to the first section. One or both sections may include one or more ribs to increase strength. The first section, the second section, or both, may include angled end portions to facilitate wind deflection and increase structural strength. The roof may be movable between an open position and a closed position via pneumatic struts, or may be fixed in position. The embodiment may further include a cargo holder comprising a front rail having a fairing coupled thereto, the fairing being oriented at substantially the same angle as an angled end portion of the first section of the roof, an end rail, and two side gates coupled to the front rail by hinges to allow access to cargo stored in the cargo holding section. The side gates may be opened or closed using an actuation handle that actuates a spring-actuated latch configured to engage or disengage a latch catch.

A solution is needed in which a roof accessory includes the accommodations needed for equipment and cargo. The disclosed roof may include a camping tent and may accommodate both externally-mounted items as well as internally-secured cargo and items. The roof may be a single tier, two-tier, or multi-tier, and may be fixed, movable, raisable, and/or removable. Disclosed embodiments:
a. may be useful for conventional and extended-length vehicle conversions;
b. may be used in combination with non-removable fixed “solid” top roofs, or with roofs that are removable and replaceable;
c. may be used in combination with movable and removable camper tops with attached camping tents;
d. may include motion-enabled roof functions with hinges, electronic linear actuators, springs, and/or other features;
e. may include built-in accommodations for typical aftermarket accessories including, but not limited to lights, cargo placement, tools, and supplies;
f. may include internal storage areas;
g. may increase vehicle cargo capacity and balance by distributing weight around a perimeter of a vehicle roof rather than concentrating weight at discrete mounting locations;
h. may include unique built-in hinged cargo rails to facilitate access to cargo during loading and unloading;
i. may include faux windows and/or built-in windows to increase internal lighting and visibility;
j. may include a roof shape configured to improve aerodynamic performance, including windward-facing angles, a graduated increase in height, a multi-tier configuration, and optionally hidden hinges and attachment structures;
k. may allow cargo mounting in the forward top area of the roof;
l. may include a roof with an increase in height along its length to accommodate internal storage receptacles, bedding, or other components beneath the roof;
m. may include a rear section of the roof to accommodate additional cargo and accessories such as solar panels;
n. may have been designed primarily for use with Jeep® models;
o. may be made using construction materials that include, but are not limited to, fiberboard core, fiberglass-strengthened polyester, carbon fiber, steel, aluminum, fiberglass-compatible paint, vinyl-type material headliner, an insulation layer, and associated attachment mechanisms; and
p. approximate dimensions for certain embodiments include 50 inches (1.2 meters) wide by 102 inches (2.5 meters) long comprising a first tier that is 5 inches (0.13 meters) tall and 42 inches (1.1 meters) deep, and a second tier that is 9 inches (0.23 meters) tall and 60 inches (1.52 meters) deep.

One or more disclosed embodiments comprise a modified rear automobile protection and attachment system to attach stock and/or custom-built bumpers to an automobile. Advantages of these embodiments include:
a. allow owners to utilize an existing stock rear bumper on an extended or lengthened vehicle conversion;
b. provide side armor protection for the rear and rear sides of the vehicle, with armor extending forward to the rear wheel well;
c. include frame extensions configured to attach to a vehicle frame rather than to a vehicle body;
d. accommodate rear vehicle entry via a built-in ladder system; and
e. accommodate tools and accessory mounting of items such as, but not limited to, a spare tire, swing out tire carrier, tools, liquid containers (e.g., water and fuel containers), lights, cameras, etc.

The foregoing and other objects, features, and advantages of the invention will become more apparent from the following detailed description, which proceeds with reference to the accompanying figures.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a perspective view from a first, automobile forward end of one embodiment of an after-market automobile accessory according to the present invention.

FIG. 2 is a perspective view from a second, automobile rearward end of one embodiment of an after-market automobile accessory according to the present invention.

FIG. 3 is perspective view from a first automobile forward end of one embodiment of an after-market automobile accessory according to the present invention, together with a cargo holder comprising an end plate/wind fairing.

FIG. 4 is perspective view from a second automobile rearward end of one embodiment of an after-market automobile accessory according to the present invention.

FIG. 5 is a perspective view from a first, automobile forward end of one embodiment of an after-market automobile accessory according to the present invention, together with a cargo holder and associated end plate/wind fairing.

FIG. 6 is a perspective front view of one embodiment of an after-market automobile accessory according to the present invention, together with a cargo holder comprising an end plate/wind fairing.

FIG. 7 is a perspective front view of one embodiment of a two-tier roof according to the present invention.

FIG. 8 is a perspective front and side view of one embodiment of a two-tier roof according to the present invention.

FIG. 9 is a perspective rear view of a two-tier roof according to one embodiment of the present invention.

FIG. 10 is a schematic view of a two-tier roof according to one embodiment of the present invention illustrating a cargo holding forward portion and a second rearward portion comprising solar panels.

FIG. 11 is a side perspective view of a cargo holder associated with the first tier of a two-tier roof, the cargo holder comprising one or more hinged gates that facilitate access to the cargo holder region, according to one embodiment of the present invention.

FIG. 12 is a side perspective view of a cargo holder associated with the first tier of a two-tier roof.

FIG. 13 is a disassembled perspective view showing components of one embodiment of a cargo holder comprising hinged gates and an end plate/wind fairing according to one embodiment of the present invention.

FIG. 14 is an assembled perspective view of the cargo holder components of FIG. 13.

FIG. 15 is an enlarged perspective view of a portion of a hinged gate of a cargo holder and an end plate/wind fairing according to one embodiment of the present invention.

FIG. 16 is a perspective front end view illustrating a ring rack, a two-tier roof, a cargo holder and a wind faring mounted to an automobile.

FIG. 17 is side perspective view of a ring rack, a two-tier roof, a cargo holder and a wind fairing mounted to an automobile, wherein the two-tier roof further comprises faux windows.

FIG. 18 is a side perspective view from the rear of an automobile illustrating a ring rack, a two-tier roof, and a cargo holder mounted to the automobile, the two-tier roof further comprising faux windows.

FIG. 19 is side perspective view of an automobile illustrating a roof in an elevated position supported by pneumatic struts, together with a pop-up tent.

FIG. 20 is a rear perspective view of an automobile illustrating a roof in an elvated position, together with a custom-made bumper and extenders for attaching the bumper to an automobile.

FIG. 21 is a perspective view illustrating embodiments of extenders for extending the length of an automobile.

FIG. 22 is a perspective view illustrating an embodiment of extenders mounted to an automobile.

FIG. 23 is a perspective view illustrating an alternative embodiment of extenders mounted to an automobile.

FIG. 24 is a perspective view illustrating certain features of one embodiment of a bumper according to the present invention, such as a step, and cargo carriers, equipment carriers, or tool carriers comprising a door and latch built into the bumper.

FIG. 25 is a perspective enlarged view of a portion of a bumper according to the present invention comprising an integral step.

FIG. 26 is a perspective view of an extension tub framework for an automobile extension tub according to one embodiment of the present invention.

FIG. 27 is a perspective view of an automobile extension tub according to one embodiment of the present invention.

FIG. 28 is a perspective view of an automobile extension tub according to one embodiment of the present invention.

FIG. 29 is a perspective view of an embodiment of a rear vehicle protection system according to the present invention.

### DETAILED DESCRIPTION OF ILLUSTRATIVE EMBODIMENTS

Unless explained otherwise, all terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and are not intended to be limiting.

The disclosure of numerical ranges should be understood as referring to each discrete point within the range, inclusive of endpoints, unless otherwise noted. Unless otherwise indicated, all numbers used in the specification or claims are to be understood as being modified by the term “about.” Accordingly, unless otherwise explicitly indicated, or unless the context would be understood by a person of ordinary skill in the art to have a more definite construction, the numerical parameters set forth are approximations that may depend on desired properties. When explicitly distinguishing embodiments from prior art, the embodiment numbers are not approximations unless the term “about” is recited.

The disclosed automobile assembly comprising one or more accessories may comprise a ring rack, a roof, a cargo holder, a custom bumper accessory, extenders and an extension tub, and a vehicle protection system.

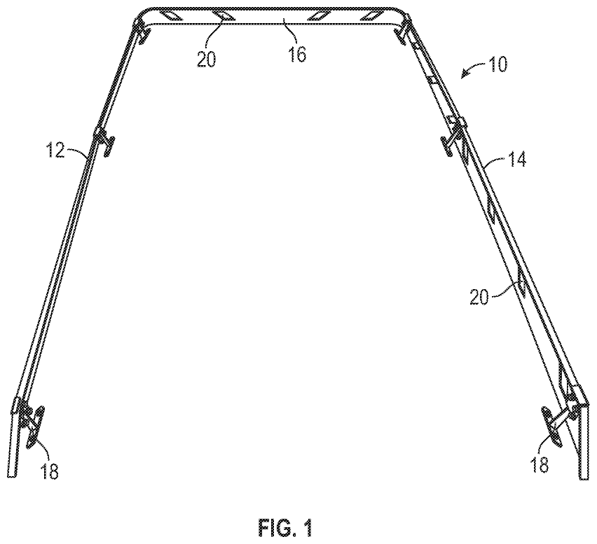

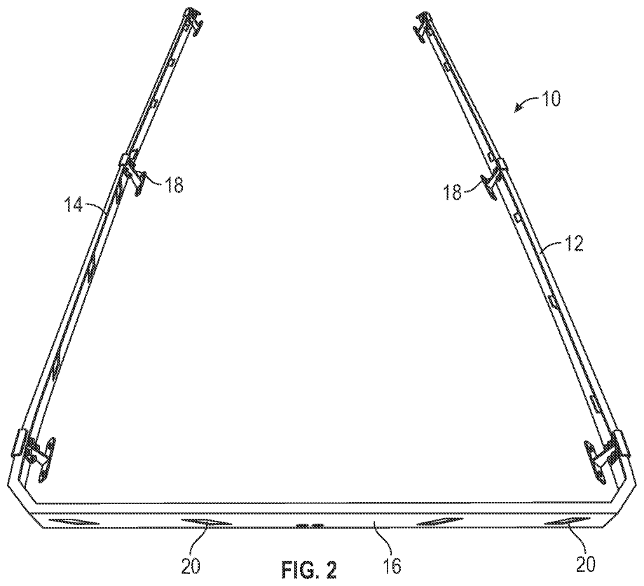

FIGS. 1-4 illustrate an after-market automobile accessory 10 according to the present invention, referred to herein as a ring rack. Ring rack 10 includes two side rails 12 and 14 and an end rail 16. Side rails 12, 14 and end rail 16 may be joined to form a unitary U-shaped ring rack 10 using any suitable technique. The ring rack 10 may be fabricated as a unitary structure. The ring rack 10 may comprise one or more mounting brackets 18 configured to attach the two side rails 12, 14 to the end rail 16. Mounting brackets may be configured to mount the ring rack to a roof of an automobile.

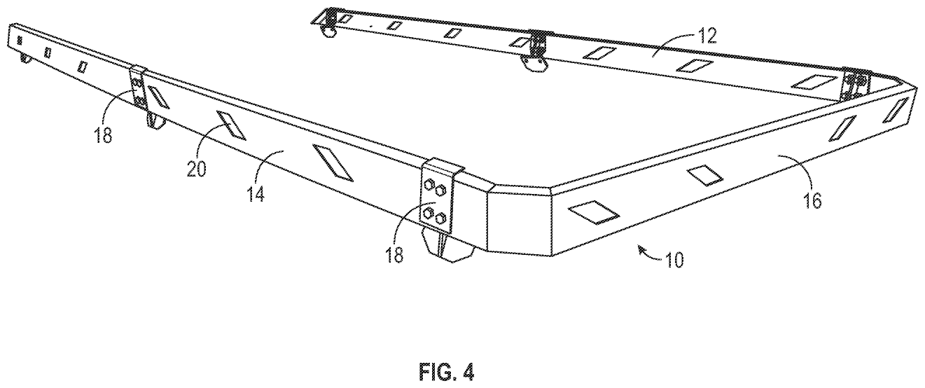

The ring rack 10 may include one or more mounting brackets 18 that allow the rack to be mounted as an after-market addition to a roof of an existing automobile. The ring rack 10 may be made from any suitable material, such as metals, with steel and aluminum being exemplary suitable materials. Metal ring racks may pose a weight issue, as many automobile roofs have a weight limitation. Accordingly, the ring rack 10 also may include a number of cut out sections 20 to reduce the weight of the metal rack, provide air flow, provide for accessory attachment, and/or may be included solely as an aesthetic feature. FIG. 4 provides a perspective view from a second, automobile rear end of ring rack 10 according to the present invention. FIG. 4 better illustrates the structure of mounting brackets 18 and further illustrates using the mounting brackets to couple side rails 12 and 14 to end rail 16.

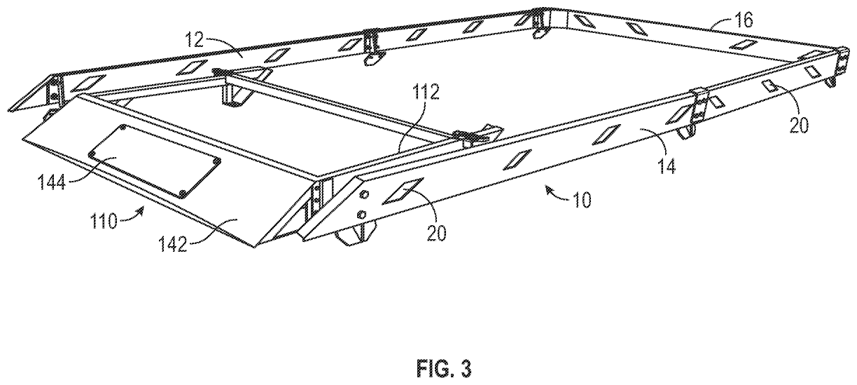

FIGS. 3, 5 and 6 illustrate an embodiment of a ring rack 10 according to the present invention and a cargo holder 110 that is positioned adjacent to or in between the open-end sections of rails 12, 14. FIG. 3 is perspective view from a first automobile forward end of one embodiment of ring rack 10 according to the present invention, together with a cargo holder 110 that comprises gates 112, an end plate/wind fairing 142 and an information plate 144 that can be used to include trademarks or other marketing indicia.

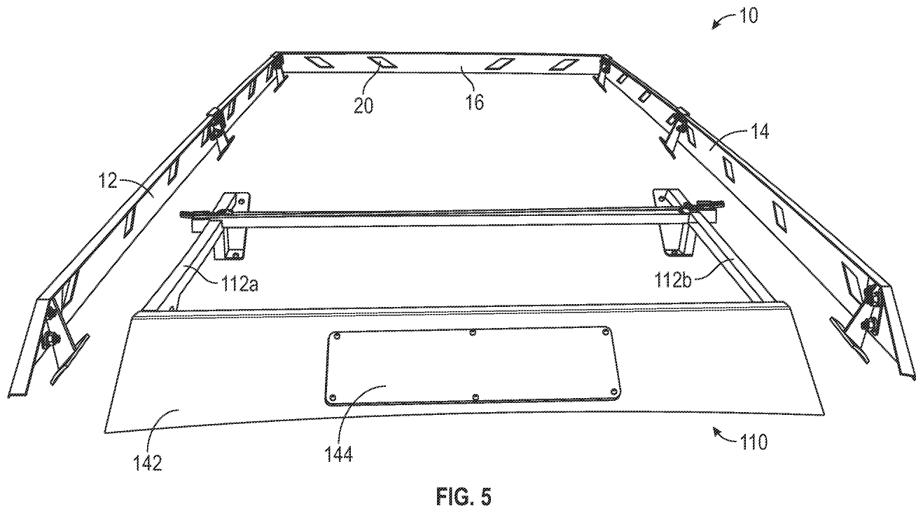

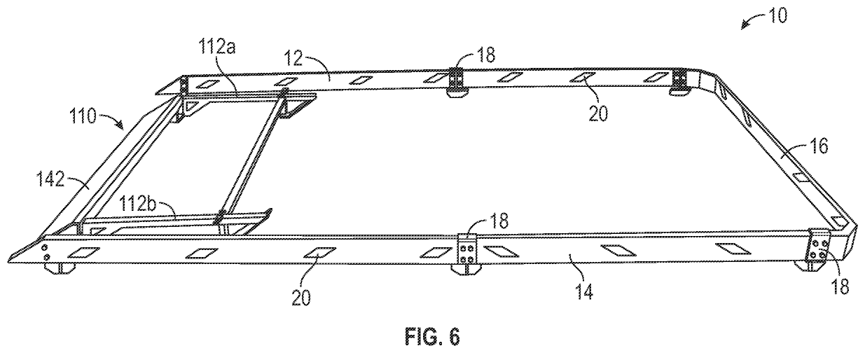

FIG. 5 is a perspective front end view from an automobile first forward end of one embodiment of a ring rack 10 according to the present invention, together with a cargo holder 110 that includes an associated end plate/wind fairing 142. FIG. 5 shows the end plate 142 including a marketing information plate 144 configured to display trademarks or other source-identifying indicia. Embodiments of the cargo holder 110 are described in more detail below. FIG. 6 is a perspective side view of a ring rack 10 according to the present invention, together with a cargo holder 110 comprising an end plate/wind fairing 142.

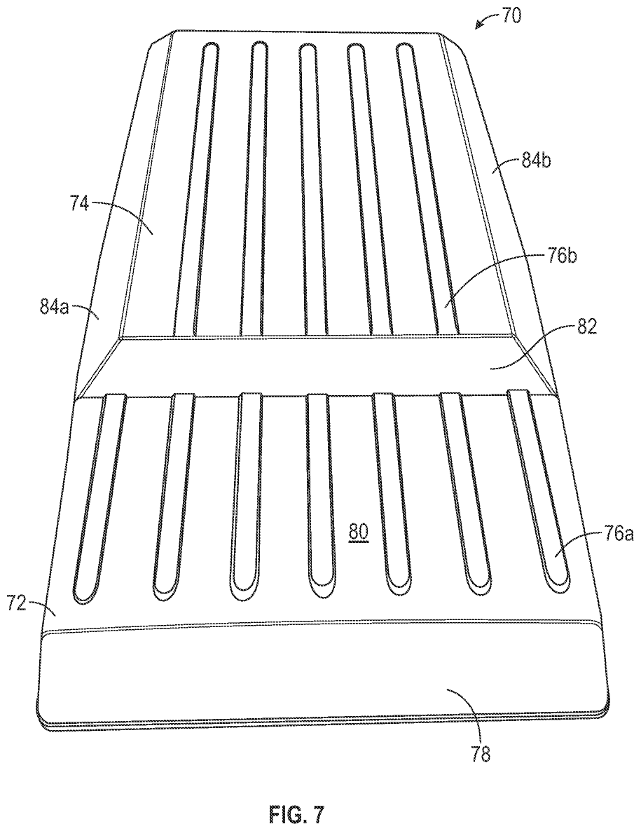

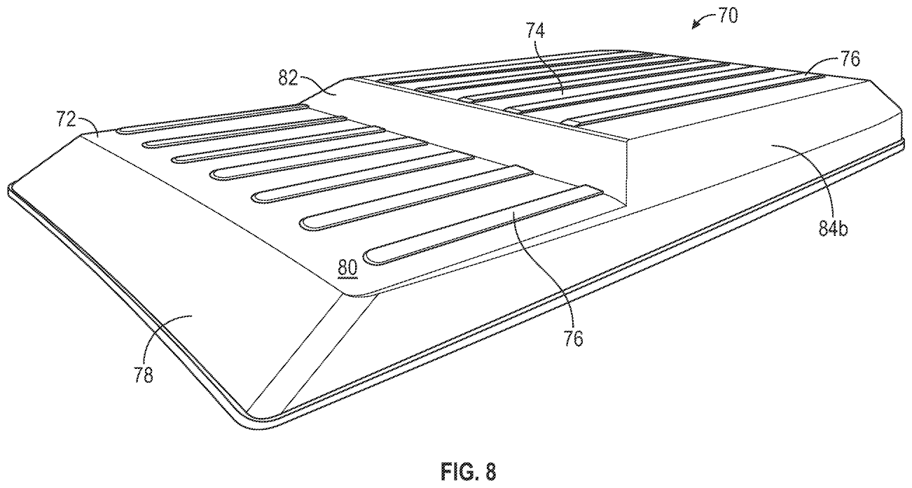

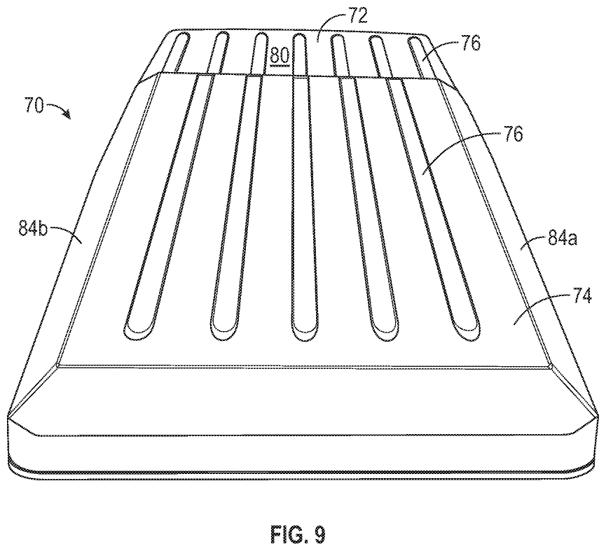

FIGS. 7-9 illustrate an embodiment of a two-tier roof 70 configured to be installed on a commercially available automobile alone or as an assembly in association with a ring rack 10. With reference to alignment with an automobile, the roof 70 includes a first forward section 72 and a second rearward section 74. Both sections 72 and 74 may include one or more ribs 76a, 76b that may be included with certain exemplary embodiments (e.g., to increase strength of a fiberglass molded roof 70, or simply for ornamental purposes such as to match the aesthetic design of automobiles on which the roof 70 is mounted).

Section 72 may include an angled end section 78 to reduce drag and provide wind deflection. Section 72 further comprises a surface 80 that, in association with the cargo holder 110, defines a cargo holding section as discussed in more detail below. Rear section 74 has an increased height relative to section 72, for example a height increase of, e.g., from 4 to 10 inches (0.1 meter to 0.25 meter) to facilitate use of disclosed accessories by a user, such as to accommodate internal features, including increased mattress thickness for associated pop-tents. Rear section 74 may further comprise an end section 82 that may be configured to include an angle to facilitate wind deflection. In one embodiment, end sections 78 and 82 are approximately 6 inches (about 0.15 meters) high and are molded to include an angle. One embodiment of the two-tier roof 70 is approximately 50 inches (1.2 meters) wide by 102 inches (2.5 meters) long overall, wherein the first tier is 5 inches (0.13 meters) tall and 42 inches (1.1 meters) long and the second tier is 9 inches (0.23 meters) tall and 60 inches (1.52 meters) long. However, these dimensions are not limiting and may vary depending on vehicle dimensions, aesthetics, and desired internal space beneath the roof 70. Two-tier roof 70 may comprise sides 84a, 84b and such sides also may be formed at an angle to facilitate air flow and/or for aesthetic purposes.

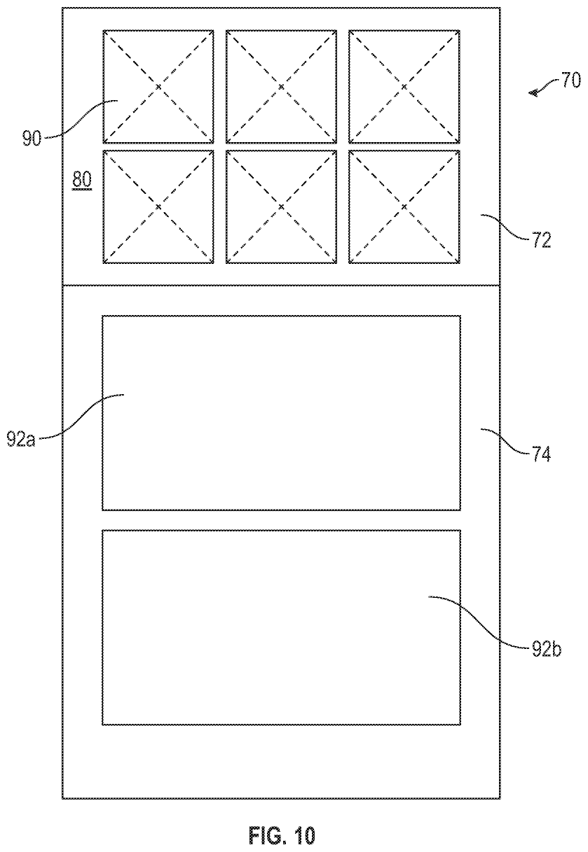

FIG. 10 is a schematic plan view of a two-tier roof 70 according to one embodiment of the present invention. The depicted two-tier roof includes a cargo holding forward section 72, and rear section 74. FIG. 10 illustrates positioning cargo, or cargo containers, 90 on surface 80 of a forward section 72. The cargo or cargo containers 90 are secured in place by a cargo holder 110 (not shown). Rear section 74 may include features selected to increase functionality, such as one or more solar panels 92a, 92b.

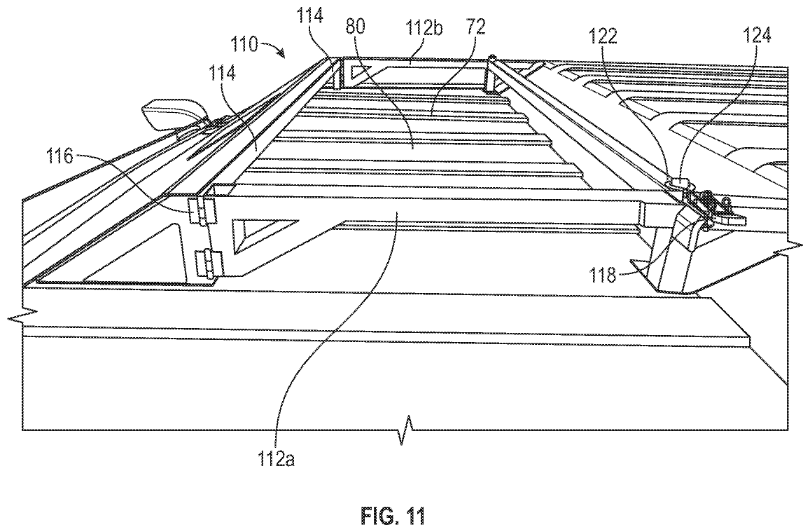

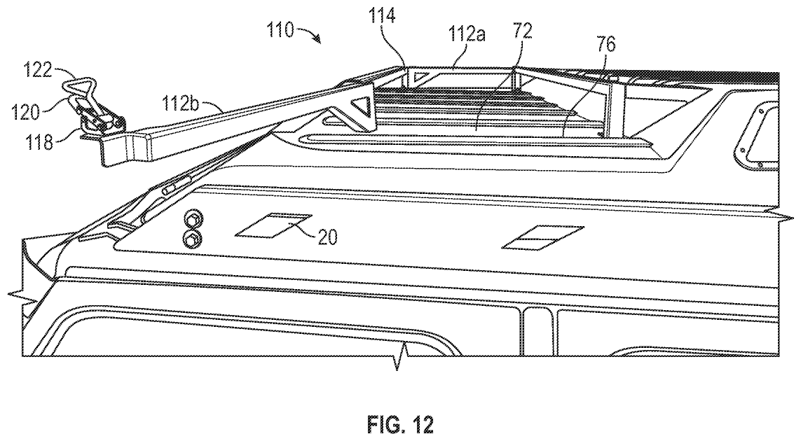

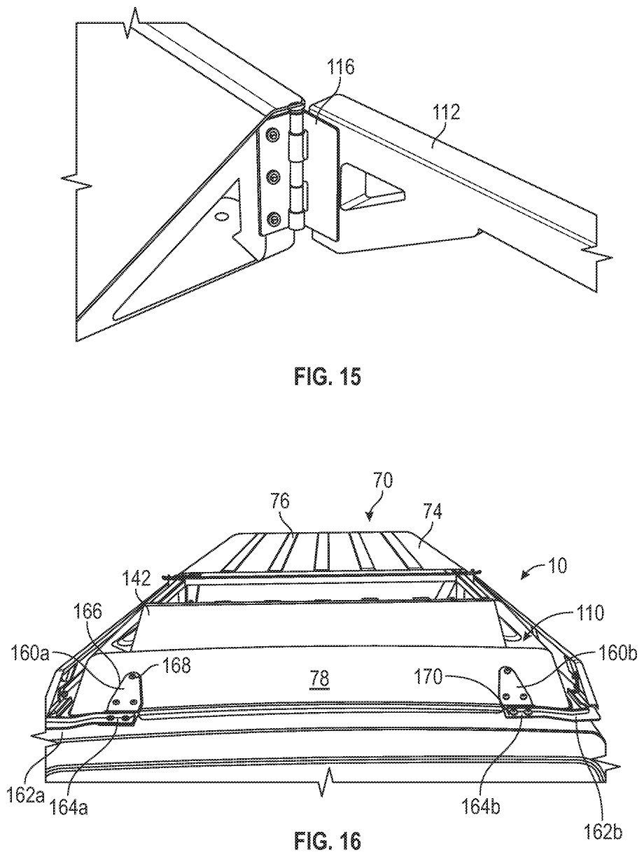

FIGS. 11 and 12 are side elevational views of a cargo holder 110 that is secured to both an automobile and to section 72 of a two-tier roof 70. The components of cargo holder 110 are associated with the first section of two-tier roof 70, and together with surface 80 define a cargo holding section. FIG. 12 shows open gate 112b that is coupled to front rail 114 by hinges 116 (see FIG. 15), thereby allowing a user access to cargo stored in this cargo holding section. FIGS. 11 and 12 further illustrate that the cargo holder 110 includes spring-actuated toggles 118 that include handle 120 to move latch 122 into or out of engagement with a catch 124 to either open or close the gates 112a, 112b. The cargo holder 110 may be coupled to an automobile and/or the roof 70.

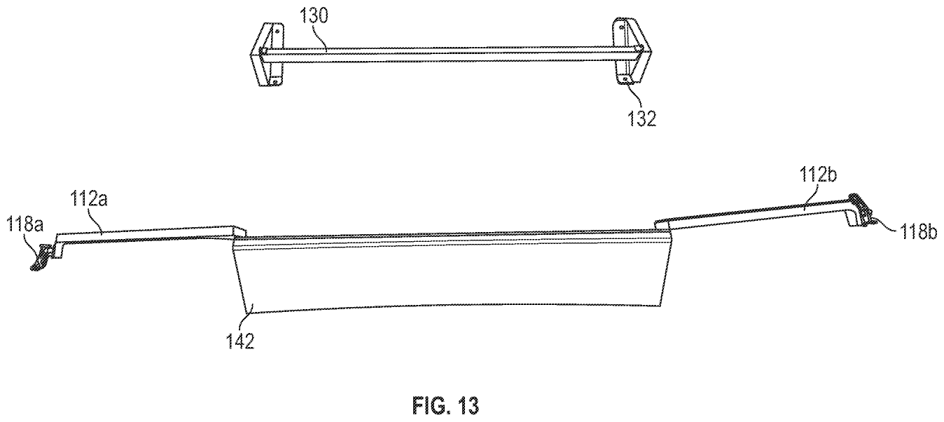

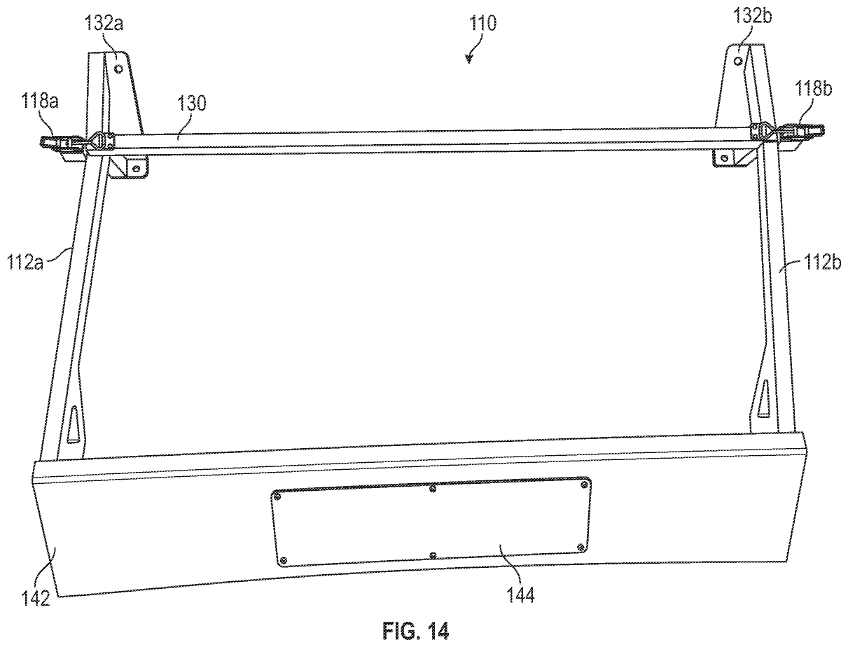

FIG. 13 is a disassembled perspective view of cargo holder 110 components, and FIG. 14 is an assembled perspective view of the cargo holder components. Cargo holder 110 comprises hinged gates 112a, 112b and end plate/wind fairing 142 that together define a cargo holder according to one embodiment of the present invention. With reference to FIGS. 13 and 14, cargo holder 110 includes a rear rail 130 and mounting brackets 132 for mounting cargo holder to a roof 70, such as a two-tier roof. Cargo holder gates 112a and 112b each includes toggles 118a, 118b for opening and closing the gates. Front portion 142 of cargo gate 110 includes fairing 142 and source of origin identifier 144 (see FIG. 14).

FIG. 16 is an automobile front end view illustrating an assembly of accessories comprising a ring rack 10, a two-tier roof 70, and a cargo holder 110 with associated fairing 142. In FIG. 16, the roof 70 is coupled to a ring rack 10 by one or more wings of hinged mounting brackets 160a, 160b, 164a, 164b and mounting bracket arms 162a, 162b. The ring rack 10 may include one or more mounting bracket arms 162 that are coupled to ring rack 10 by mounts 164a, 164b. Hinged mounting brackets 160 include a bracket plate 166, attached to the front portion 78 of the roof 70 by one or more bolts or fasteners 168. The mounting brackets may be coupled to the ring rack 10 and automobile by bolts or fasteners 170. The fairing 142 is oriented at substantially the same angle as the front portion 78 of section 72 of the roof 70 to reduce drag and facilitate air flow over the top of the assembly.

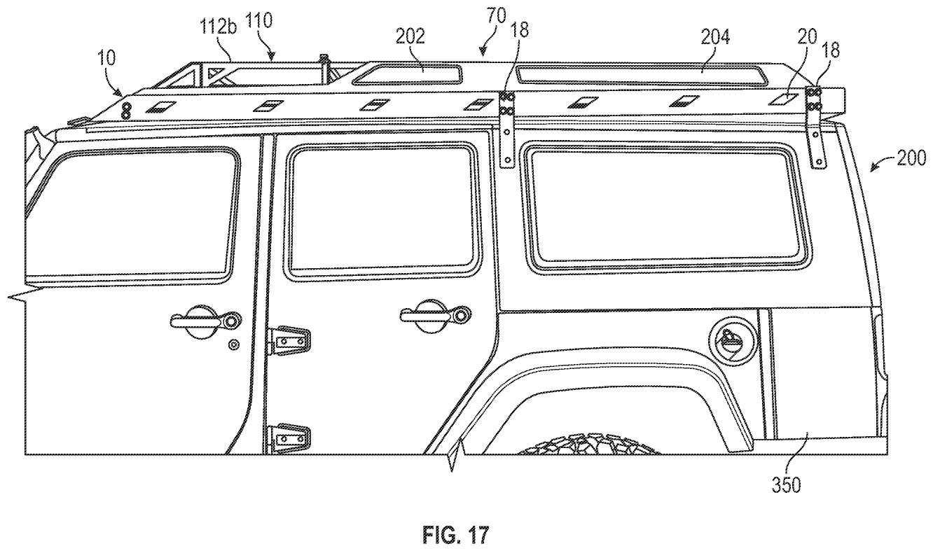

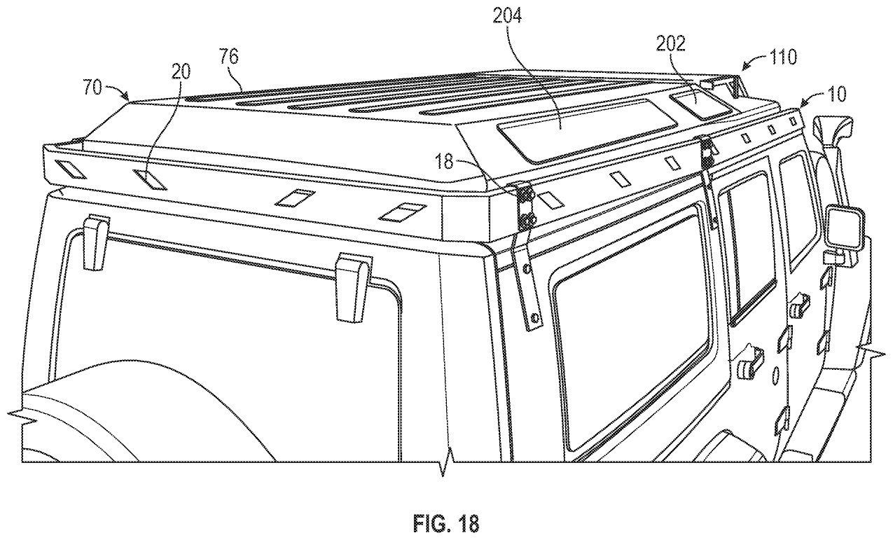

FIG. 17 is side perspective view of an automobile 200, and FIG. 18 is a rear perspective view of the automobile, together with an assembly of accessories comprising a ring rack 10, a two-tier roof 70, and a cargo holder 110. Multiple mounting brackets 18 couple the ring rack 10 to the automobile 200. The depicted ring rack 10 includes cutouts 20, and the depicted roof 70 comprises a forward window or faux window 202 and/or a rear window or faux window 204.

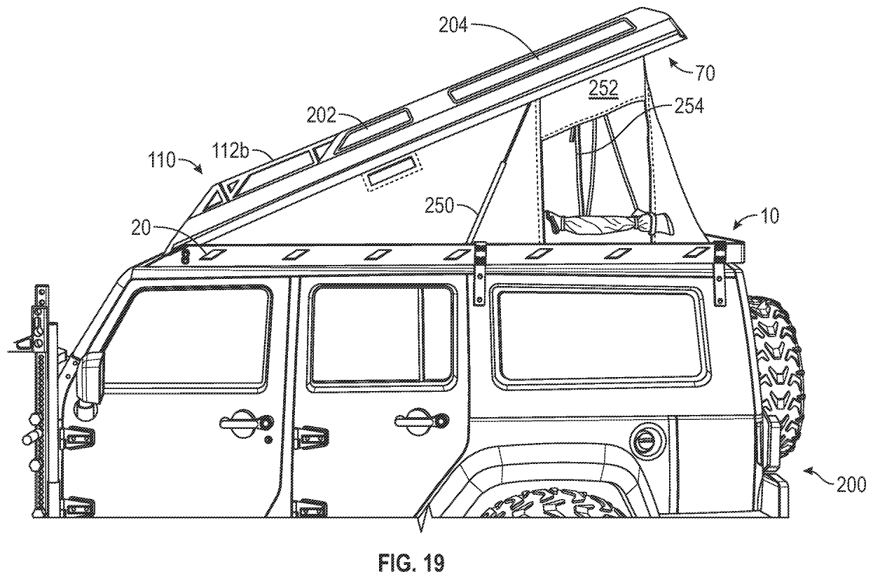

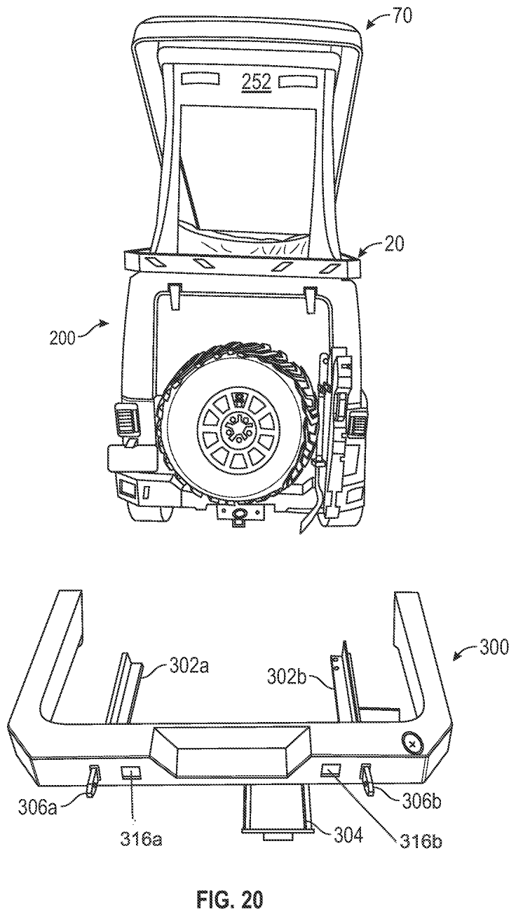

FIG. 19 is side view of an automobile 200, and FIG. 20 is an end view of an automobile 200, illustrating the roof 70 in an elevated or open position supported by pneumatic struts 250. FIGS. 19 and 20 also illustrate a pop-up tent 252 that can be provided by a third-party manufacturer or can be a custom-made component of disclosed embodiments. A user can place the roof 70 in an elevated or open position by opening the tail gate and window, if present, of the automobile 200, and the user may apply an upward force to raise the roof 70 to an open or elevated position. The assembly can include one or more straps 254 to allow the user to close the roof 70, and to further secure the roof in a closed position, as desired.

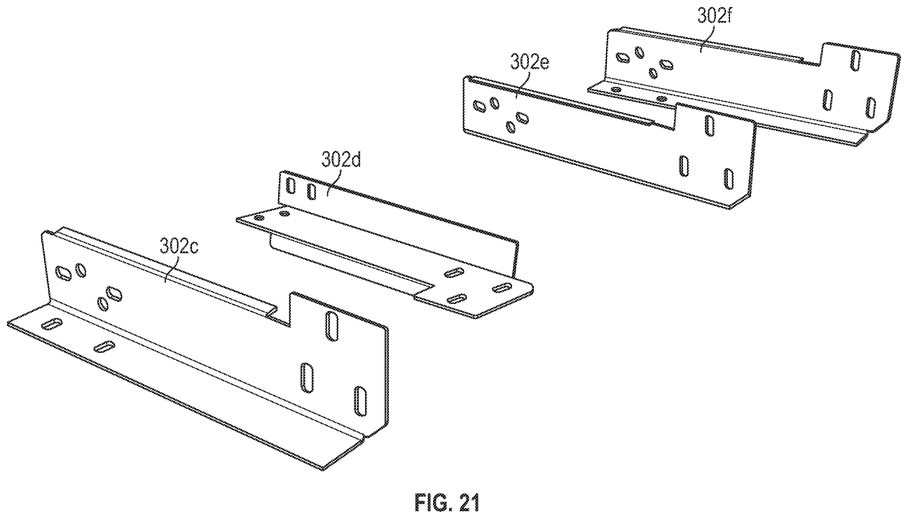

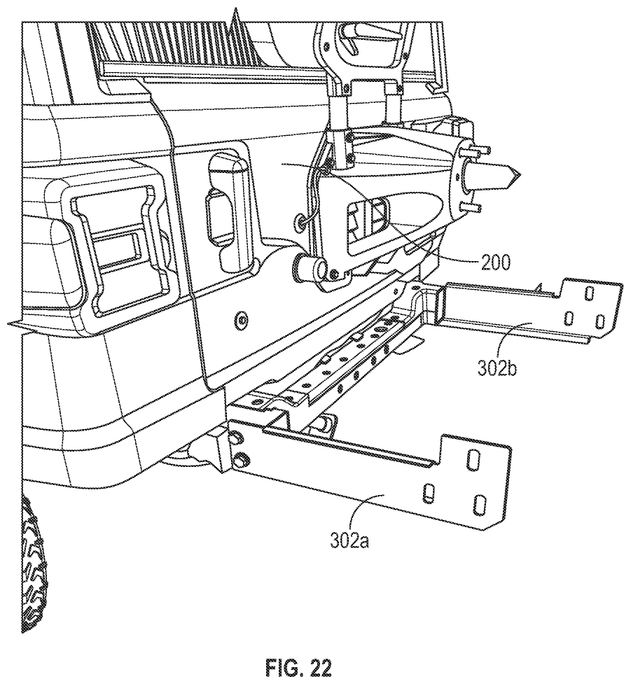

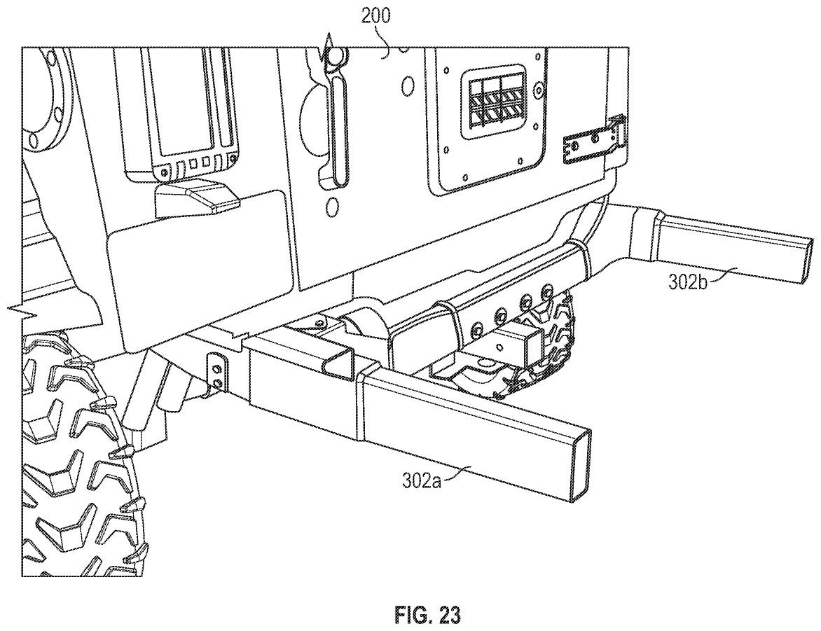

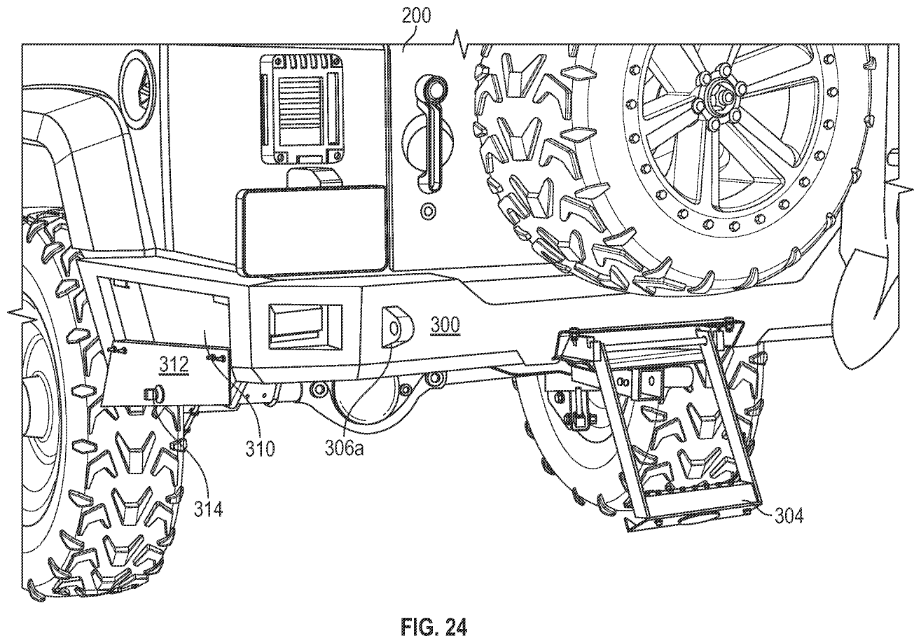

FIG. 20 illustrates an exemplary embodiment of a custom-made bumper 300 positioned adjacent to the automobile 200. FIG. 24 illustrates an embodiment of a bumper 300 mounted to an automobile 200. Bumper 300 is mounted to the automobile 200 using extension mounting brackets 302a, 302b. Additional views of different embodiments of extension brackets 302c-302f are provided in FIG. 21. A person of ordinary skill in the art will appreciate that the particular mounting brackets 302 that are selected will depend on the automobile 200 to which the bumper is to be attached, as well as the extension length required or desired to couple a custom bumper 300 to the automobile. FIG. 22, for example, is a perspective view of a first embodiment of extension mounting brackets 302a, 302b mounted to the automobile 200. FIG. 23 illustrates a different embodiment of extension mounting brackets 302a, 302b mounted to the automobile 200.

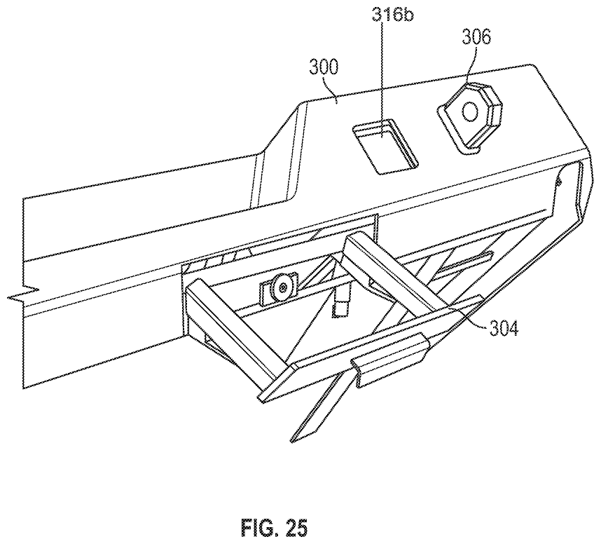

With reference to FIGS. 20, 24 and 25, the bumper 300 includes a number of features to increase the utilitarian benefit of the bumper for the user. For example, the bumper 300 includes a step 304 to facilitate a user's access to the interior of the automobile 200 and to allow a user to raise the roof 70. The bumper 300 also includes couplers 306a, 306b to which items, such as tow ropes or chains, can be coupled. FIG. 24 illustrates that disclosed embodiments of bumpers 300 can include built in storage sections 310 that include an access door 312 and latch 314. Built-in storage sections 310 can be included on both sides of the bumper 300. The bumper 300 can also include cut-out accommodations for vehicle lights 316a, 316b (see FIGS. 20 and 25).

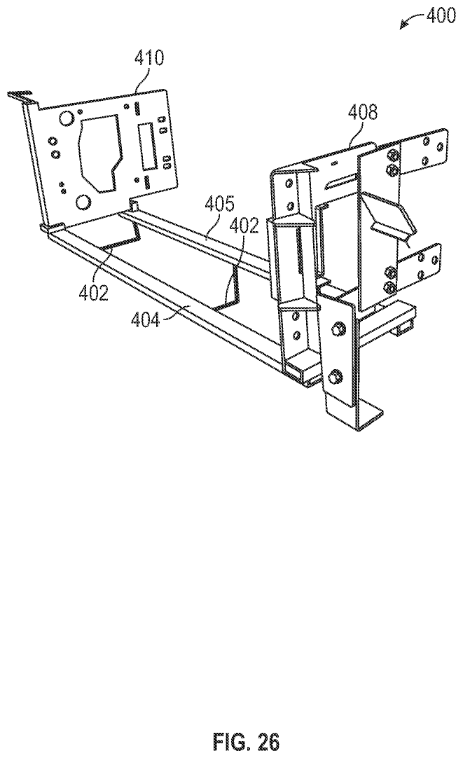

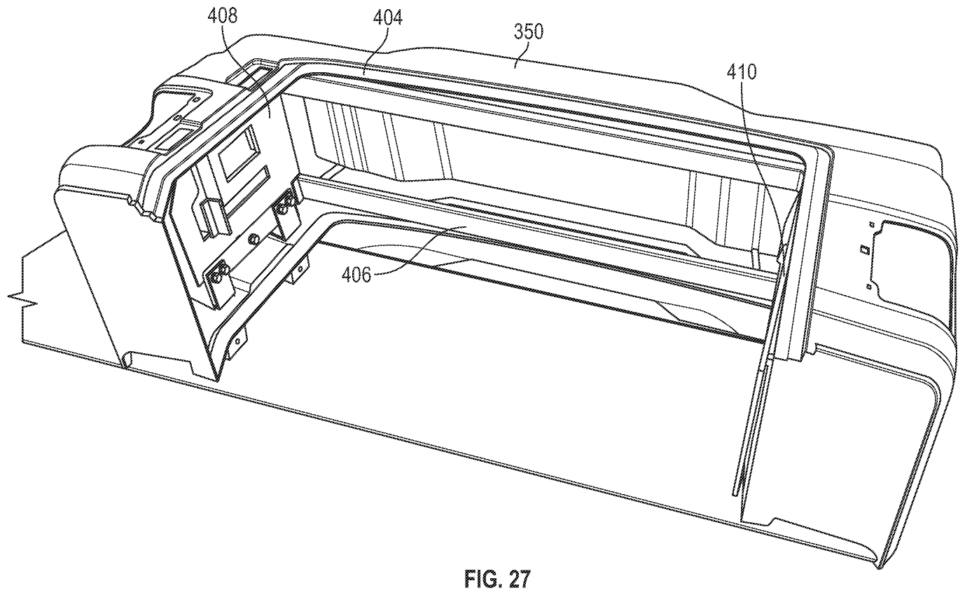

FIG. 17 is a side view of an automobile 200 that includes an extension tub 350. Extension brackets 302 and extension tub frames 400 (not shown in FIG. 17; see FIGS. 26-28) allow extension tubs 350 to be mounted to the automobile 200. FIG. 26 is a perspective view illustrating one embodiment of an extension tub frame 400 and extension mounting brackets 402. Frame 400 includes one or more mounting brackets 402, a front rail 404, a rear rail 406, and side plates 408 and 410. Extension tubs 350 can be associated with or formed about tub frame 400.

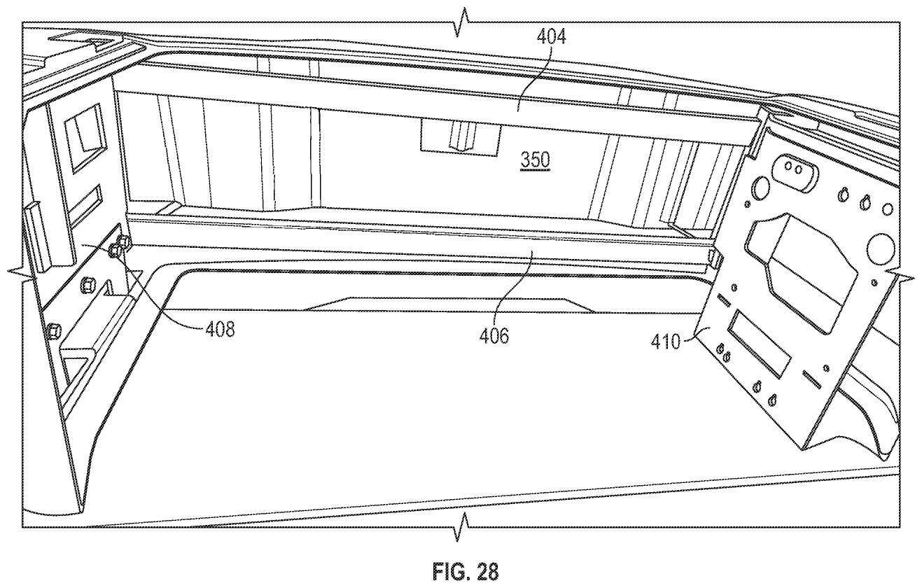

Exemplary embodiments of extension tubs 350 associated with tub frames 400 are best illustrated by FIGS. 27 and 28. FIG. 27 is a perspective view of an automobile extension tub 350, and FIG. 28 is a perspective view of an exemplary automobile extension tub 350 according to disclosed embodiments of the present invention. Tub 350 is shown associated with tub frames 400 that include rails 404 and 406, and side plates 408 and 410. Extension tubs 350 allow the length of an automobile 200 to be extended to accommodate the increased length that may be associated with a ring rack 10 and a roof 70.

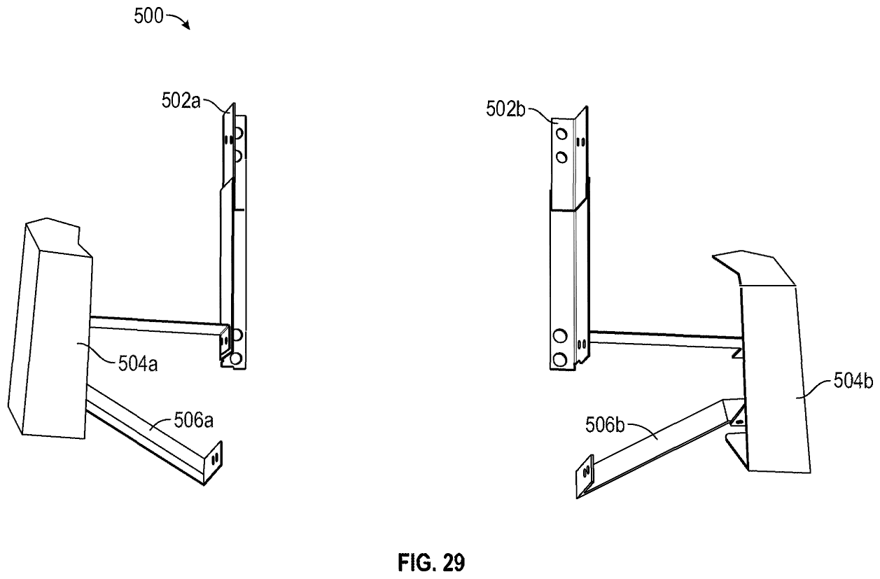

FIG. 29 provides a view of one embodiment of a rear and rear side vehicle protection system 500. Protection system 500 includes frame extenders 502a, 502b, and side protectors 504a, 504b.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention, the scope of which is defined by the appended claims.

I claim:

1. An automobile roof assembly, comprising:
a roof configured to be attached to a top portion of an automobile, the roof comprising a first forward section and a second rearward section, wherein the second rearward section has an increased height relative to the first forward section;
a cargo holder attached to the first forward section comprising:
a front rail;
an end rail; and
at least one movable side gate extending between the front rail and the end rail, each side gate being releasably coupled to at least one of the front rail or the end rail and movable between an open and a closed position;
wherein the first forward section defines a surface that, in association with the cargo holder, defines a cargo holding section.

2. The roof assembly of claim 1, wherein the first forward roof section is positioned at a forward end of the roof and configured to be disposed proximate to a front windshield of the vehicle when mounted thereto; and wherein the second rearward roof section is positioned at a rearward end of the roof structure and directly rearward of the first roof section; and wherein the second roof section has a height greater than a height of the first roof section.

3. The roof assembly of claim 1, wherein the roof is a two-tier roof.

4. The roof assembly of claim 1, further comprising a ring rack comprising:
a first side rail, having a first end and a second end;
a second side rail having a first end and a second end;
an end rail connecting said second end of said first side rail and said second end of said second side rail; and
one or more attachment members for securing said ring rack to a top perimeter of said vehicle;
wherein said roof assembly opens and closes without interference from said ring rack disposed around the sides and rear perimeter of said vehicle.

5. The roof assembly of claim 4, wherein said ring rack further comprises arms that connect said ring rack to the first forward roof section and to the vehicle.

6. An attachable roof assembly configured for mounting to a vehicle, the roof assembly comprising:
a two-tier roof structure, comprising:
a first forward roof section; and
a second rear roof section positioned rearward of the first forward roof section;
wherein the second rear roof section has a height greater than a height of the first forward roof section; and
a mounting assembly configured to couple the roof structure to the vehicle;
wherein the roof structure is movable relative to the vehicle between a closed position and an open position; and
wherein the roof structure is coupled to the vehicle in a manner that allows at least the rear portion of the roof structure to be raised and lowered.

7. The roof assembly of claim 6, wherein the first forward roof section comprises a cargo holding roof section, the first forward roof section extending from a forward edge disposed proximate to a front windshield of the vehicle when attached to the vehicle, said first forward roof section comprising a planar surface elevated and supported by an angled end section and two side edges, said first forward section having a first roof height corresponding to a height of the planar surface above a bottom edge of said roof structure.

8. The roof assembly of claim 7, wherein the second rear roof section is positioned rearward of the first roof section, the second roof section comprising a planar surface elevated and supported by an end section, a rear edge, and two side edges, said second rear section having a second roof height corresponding to a height of the second roof section planar surface above the bottom edge of the roof structure, wherein the second roof height is greater than the first roof height, and wherein the second roof section has a longitudinal axis that is equal to or greater than the longitudinal axis of said first roof section.

9. The roof assembly of claim 6, wherein, when attached to the vehicle, the forward edge of the first forward roof section is pivotally coupled to the vehicle, and lift mechanisms are positioned and configured to selectively raise and lower a rear portion of the two-tiered roof structure.

10. The roof assembly of claim 6, further comprising a cargo holder having a front rail attached to said first forward roof section, the cargo holder further comprising a first side gate and a second side gate, said first side gate having a first end that is coupled to a first end of said front rail, and said second side gate having a first end that is coupled to a second end of said front rail, the cargo holder further comprising a rear rail, wherein a second end of the first side gate is releasably attachable to a first end of said rear rail and wherein a second end of the second side gate is releasably attachable to a second end of said rear rail.

11. The roof assembly of claim 6, further comprising a cargo holder having a front rail attached to said first forward roof section, the cargo holder further comprising a first side gate and a second side gate, said first side gate having a first end that is releasably coupled to a first end of said front rail, and said second side gate having a first end that is releasably coupled to a second end of said front rail, the cargo holder further comprising a rear rail, wherein a second end of the first side gate is coupled to a first end of said rear rail and wherein a second end of the second side gate is coupled to a second end of said rear rail.

12. The roof assembly of claim 6, further comprising a U-shaped ring rack comprising:
a first side rail, having a first end and a second end;
a second side rail having a first end and a second end;
an end rail connecting said second end of said first side rail and said second end of said second side rail; and
one or more attachment members for securing said ring rack to a top perimeter of said vehicle;
wherein said roof assembly opens and closes without interference from said ring rack disposed around the sides and rear perimeter of said vehicle.

13. The roof assembly of claim 6, wherein one or both of the first section and the second section include a plurality of ribs formed in the planar surfaces to increase the strength of the roof.

14. An attachable roof assembly configured for mounting to a vehicle, the roof assembly comprising:
a roof structure, comprising:
a first forward roof section comprising a planar surface elevated and supported by an angled end section and two side edges, said first forward section having a first roof height corresponding to a height of the planar surface above a bottom edge of said roof structure; and
a second rear roof section disposed rearward of the first roof section, the second roof section comprising a planar surface elevated and supported by an end section, a rear edge, and two side edges, said second rear section having a second roof height corresponding to a height of the second roof section planar surface above the bottom edge of the roof structure, wherein the second roof height is greater than the first roof height;
wherein the roof structure is movable relative to the vehicle between a closed position and an open position; and
wherein the roof structure is coupled to the vehicle in a manner that allows at least the rear portion of the roof structure to be raised and lowered.

15. The roof assembly of claim 14, further comprising a cargo holder coupled to said first forward roof section, the cargo holder further comprising at least one moveable gate.

16. The roof assembly of claim 15, wherein the at least one movable gate includes a latch mechanism configured to selectively secure the gate.

17. The roof assembly of claim 14, further comprising a ring rack comprising:
a first side rail, having a first end and a second end;
a second side rail having a first end and a second end;
an end rail connecting said second end of said first side rail and said second end of said second side rail; and
one or more attachment members for securing said ring rack to a top perimeter of said vehicle;
wherein said roof assembly opens and closes without interference from said ring rack disposed around the sides and rear perimeter of said vehicle.

18. The roof assembly of claim 17, wherein said ring rack further comprises one or more cutouts formed through one or more of the first side rail, the second side rail, and/or the end rail, said cutouts being configured for attachment of accessories, wherein said roof assembly is configured to be raised and lowered without requiring removal of the accessories attached to the ring rack.

19. The roof assembly of claim 18, wherein said ring rack further comprises arms that connect said ring rack to the first forward roof section and to the vehicle.

20. The roof assembly of claim 14, wherein the first roof section defines a first interior volume beneath the roof body, and wherein the second roof section defines a second interior volume beneath the roof body, the second interior volume being greater than the first interior volume.
